(19) United States
(12) Patent Application Publication
(10) Pub. No.: US 2019/0180374 A1
(43) Pub. Date: Jun. 13, 2019

(54) Computer Based Method of Pricing Equity Indexed Annuity Product with Enhanced Free Partial Withdrawal

(71) Applicant: Genesis Financial Products, Inc., Mississauga (CA)

(72) Inventors: Derek Ferguson, Erin (CA); Richard Kado, Oakville (CA); John Adam Rose, Toronto (CA); Marc Verrier, Caledon (CA)

(21) Appl. No.: 16/208,259

(22) Filed: Dec. 3, 2018

Related U.S. Application Data
(63) Continuation of application No. 11/518,808, filed on Sep. 11, 2006, now abandoned.
(60) Provisional application No. 60/759,231, filed on Jan. 13, 2006.

(51) Int. Cl. G06Q 40/06; G06Q 40/04

(52) U.S. Cl. CPC G06Q 40/06; G06Q 40/04

(57) ABSTRACT

The present invention broadly comprises a computer-based method for determining a set of equity-indexed crediting parameters C for an enhanced free partial withdrawal equity-indexed deposit product, including: generating a set of yield curve and equity index scenarios consistent with valuation parameters; setting a trial value Cᵢ for the set of equity-indexed crediting parameters C; generating a set of trial values for a T′ᵢ and a Wᵢ for each scenario; calculating corresponding values for an A for each scenario; calculating an observed distribution D of profitability using the scenarios; comparing D with an R; and, in response to comparing, computing a revised trial value Cᵢ₊₁ for C, where the steps of setting, generating, calculating values for A, calculating D, and comparing are performed by at least one general-purpose computer specially programmed to perform the steps of setting, generating, calculating values for A, calculating D, and comparing.

### CROSS-REFERENCE TO RELATED APPLICATIONS

This application claims the benefit under 35 U.S.C. § 119(e) of U.S. Provisional Application No. 60/759,231 filed Jan. 13, 2006.

### REFERENCE TO COMPUTER PROGRAM LISTING APPENDIX

The present application includes a computer program listing appendix on compact disc. Two identical compact discs are provided herewith. Each compact disc contains an ASCII text file of the computer program listing as follows:

### Filename: apl.1st

Size: 5,903,224 bytes

### Date Created: Jan. 11, 2006

### Filename: LMM1.DPR

Size: 38,517 bytes

### Date Created: Jan. 11, 2006

### Filename: Rmem4p.dpr

Size: 29,371 bytes

### Date Created: Jan. 11, 2006

### Filename: SIMPLX.CPP

Size: 4,445 bytes

### Date Created: Jan. 11, 2006

The computer program listing appendix is hereby expressly incorporated by reference in the present application.

### FIELD OF THE INVENTION

The present invention relates to a computer-based method for an equity indexed annuity with a simple and clear structure which enables an investor to capitalize on the rewards of indexing while providing access to funds without onerous clawbacks of accrued index benefits.

### BACKGROUND OF THE INVENTION

According to AARP's Survey of Consumer Finance, 54% of Baby Boomers do not want any risk associated with their investments. This aversion to risk is the primary reason why hybrid products, those offering a combination of upside potential while providing downside protection, have flourished over the last decade.

Financial planners often use a concept called “Capital Preservation”. A portion of the client's principal is invested with guaranteed fixed interest sufficient to grow back to the original principal at the end of the desired investment horizon. This guarantees that the client will get their principal at that time. The remainder is invested in equity markets, providing the potential for excess return. Unfortunately, with today's low interest rates, an investor needs to put almost all the money in fixed interest, leaving very little in stocks. For example, if a client has $100,000 to invest over a 4-year time horizon, and earns a 4-year guaranteed rate of 4%, then they must put $85,480 in fixed interest, leaving only $15,520 invested in equities. In other words, less than 16% of funds reflect equity market performance. As a result, the Capital Preservation concept is no longer workable in its traditional format.

One of the most popular hybrid products over the last decade has been the Equity Indexed Annuity. Equity Indexed Annuity products offer some significant advantages for consumers. Other products being marketed are either too complex or lack the benefits and optionality of the present invention.

### BRIEF SUMMARY OF THE INVENTION

The Balance Plus Annuity (BPA) is founded on a simple concept and provides a clear structure that highlights the potential rewards of indexing while providing access to funds without onerous penalties and clawbacks of accrued index benefits. There is no product on the market with the features incorporated in BPA. BPA takes these advantages and adds a level of flexibility and control that currently doesn't exist making it one of the most consumer friendly products on the market today.

BPA incorporates a unique balanced allocation of earnings that capitalizes on the well established time proven balanced allocation strategies. This crediting rate strategy eliminates the modifiers that add complexity and limit growth. In addition, BPA has unique liquidity features and death benefits. This balanced approach and combination of benefits sets it apart from any other EIA in the market place today. The product has indexing terms of 4 years. Key features and benefits of BPA include: principal guarantee, less early withdrawal charges; minimum guaranteed earnings; simple balanced allocation strategy offering the opportunity for index growth without complicated formulas and modifiers; lock-in privilege that can be triggered at any time; unique enhanced free partial withdrawal feature that eliminates any earnings penalty, and a unique rollup death benefit enhancement rider.

The present invention broadly comprises a computer-based method for determining a set of equity-indexed crediting parameters C for an enhanced free partial withdrawal (EFPW) equity-indexed deposit product, C determined at the time of product purchase, the product including a set of profitability requirements R, a principal amount P, an account value A, a cumulative enhanced free partial withdrawal limit L, and a term T, with R, P, A, L, T, a set of withdrawal times T′ᵢ<=T and withdrawal amounts Wᵢ determined by the purchaser after the time of purchase, and a growth-to-date factor Gᵢ>=1 determined by the seller at T′ᵢ using the equity-indexed crediting parameters C such that if the cumulative withdrawal Σ Wᵢ is no greater than the cumulative withdrawal limit L then each withdrawal Wᵢ reduces the account value A by only Wᵢ/Gᵢ (that is, no more than dollar for dollar) and if the running sum of the withdrawal amounts Σ Wᵢ is greater than the cumulative withdrawal limit L then each withdrawal exceeding the limit reduces the account value A by the excess (that is, dollar for dollar), including: generating a set of yield curve and equity index scenarios consistent with valuation parameters; setting a trial value Cᵢ for C; generating a set of trial values for T′ᵢ and Wᵢ for each the scenario; calculating corresponding values for A for each the scenario; calculating an observed distribution D of profitability using the scenarios; comparing D with R; and, in response to the comparing, computing a revised trial value Cᵢ₊₁ for C, where the steps of setting, generating, calculating values for A, calculating D, and comparing are performed by at least one general-purpose computer specially programmed to perform the steps of setting, generating, calculating values for A, calculating D, and comparing.

In some aspects, the method includes: specifying at least one point-to-point equity index credit (PPEIC) by the set of equity-indexed crediting parameters C; and, calculating the at least one PPEIC using a percentage of an increase in an equity index, credited at the end of each policy year for the equity index, the at least one PPEIC no less than an annual minimum value, where the steps of specifying and calculating are performed by the at least one general-purpose computer.

In some aspects, the method includes: specifying at least one PPEIC by the set of equity-indexed crediting parameters C; and, calculating the at least one PPEIC using a percentage of an increase in an equity index, credited at the end of each policy year for the equity index, the at least one PPEIC no less than an annual minimum value, and the at least one PPEIC no greater than an annual maximum value, where the steps of specifying and calculating are performed by the at least one general-purpose computer.

In some aspects, the method includes: specifying at least one point-to-average equity index credit (PAEIC) by the set of equity-indexed crediting parameters C; and, calculating the at least one PAEIC using a percentage of an increase in an equity index from a year-start value to an average of values over a policy year for the equity index, credited at the end of each policy year for the equity index, the at least one PAEIC no less than an annual minimum value, where the steps of specifying and calculating are performed by the at least one general-purpose computer.

In some aspects, the method includes: specifying at least one point-to-average equity index credit specified by the set of equity-indexed crediting parameters C; and, calculating the at least one PAEIC using a percentage of an increase in an equity index from a year-start value to an average of values over a policy year for the equity index, credited at the end of each policy year for the equity index, the at least one PAEIC no less than an annual minimum value, and the at least one PAEIC no greater than an annual maximum value, where the steps of specifying and calculating are performed by the at least one general-purpose computer.

In some aspects, the method includes: specifying at least one PPEIC by the set of equity-indexed crediting parameters C; and, calculating the at least one PPEIC using a percentage of an increase in an equity index, credited at the end of an index interval equal to an integral number N of policy years, the at least one PPEIC it no less than a minimum value calculated during each index interval, where the steps of specifying and calculating are performed by the at least one general-purpose computer.

In some aspects, the method includes: specifying at least one PPEIC by the set of equity-indexed crediting parameters C; and, calculating the at least one PPEIC using a percentage of an increase in an equity index, credited at the end of an index interval equal to an integral number N of policy years, the at least one PPEIC no less than a minimum value and the at least one PPEIC no greater than a maximum value calculated during each index interval, where the steps of specifying and calculating are performed by the at least one general-purpose computer.

In some aspects, the method includes: specifying at least one PAEIC by the set of equity-indexed crediting parameters C; and, calculating the at least one PAEIC using a percentage of an increase in an equity index from a year-start value to an average of values over an index interval equal to an integral number N of policy years, credited at the end of the index interval, the at least one PAEIC no less than a minimum value calculated during each index interval, where the steps of specifying and calculating are performed by the at least one general-purpose computer.

In some aspects, the method includes: specifying at least one PAEIC by the set of equity-indexed crediting parameters C; and, calculating the at least one PAEIC using a percentage of increase in an equity index from a starting value to an average of values over an index interval equal to an integral number N of policy years, credited at the end of the index interval, the at least one PAEIC no less than a minimum value, and the at least one PAEIC no greater than a maximum value calculated during each index interval, where the steps of specifying and calculating are performed by the at least one general-purpose computer.

In some aspects, the method includes: specifying at least one PPEIC by the set of equity-indexed crediting parameters C; calculating the at least one PPEIC using a weighted sum, the weighted sum adding a compounded value calculated using a declared rate to a percentage of change in an equity index; and, crediting the at least one PPEIC at the end of an index interval equal to an integral number N of policy years, the at least one PPEIC no less than a minimum value during each index interval, where the steps of specifying, calculating, and crediting are performed by the at least one general-purpose computer.

In some aspects, the method includes: specifying at least one PPEIC by the set of equity-indexed crediting parameters C; calculating the at least one PPEIC using a weighted sum, the weighted sum adding a compounded value calculated using a declared rate to a percentage of change in an equity index; and, crediting the at least one PPEIC at the end of an index interval equal to an integral number N of policy years, the at least one PPEIC no less than a minimum value, and the at least one PPEIC no greater than a maximum value during each index interval, where the steps of specifying, calculating, and crediting are performed by the at least one general-purpose computer.

In some aspects, the method includes: specifying at least one PAEIC by the set of equity-indexed crediting parameters C; calculating the at least one PAEIC using a weighted sum, the weighted sum adding a compounded value calculated using a declared rate to a percentage of change in an equity index from a starting value to an average of values over an index interval equal to an integral number N of policy years; and, crediting the at least one PAEIC at the end of the index interval, the at least one PAEIC no less than a minimum value during each index interval, where the steps of specifying, calculating, and crediting are performed by the at least one general-purpose computer.

In some aspects, the method includes: specifying at least one PAEIC by the set of equity-indexed crediting parameters C; calculating the at least one PAEIC using a weighted sum, the weighted sum adding a compounded value calculated using a declared rate to a percentage of change in an equity index from a starting value to an average of values over an index interval equal to an integral number N of policy years; and, crediting the at least one PAEIC at the end of the index interval, the at least one PAEIC no less than a minimum value, and the at least one PAEIC no greater than a maximum value during each index interval, where the steps of specifying, calculating, and crediting are performed by the at least one general-purpose computer.

It is a general object of the present invention to provide a computer-based method for an equity indexed annuity with a simple and clear structure which enables an investor to capitalize on the rewards of indexing while providing access to funds without onerous clawbacks of accrued index benefits.

These and other objects and advantages of the present invention will be readily appreciable from the following description of preferred embodiments of the invention and from the accompanying drawings and claims.

### DETAILED DESCRIPTION OF THE INVENTION

Unless stated otherwise, it should be understood that any ages, rates, percentages, temporal intervals, or other numeric values shown below are for purposes of illustration only and that other ages, rates, percentages, temporal intervals, and numeric values are included in the spirit and scope of the claimed invention.

BPA is an equity indexed annuity (EIA) which improves on the capital preservation concept by consolidating fixed interest and equity indexed portions into a single product, and providing the principal guarantee for the product rather than for each component. The resulting product allows 35-40% of assets to reflect equity market performance (versus 16% in a classic Capital Preservation plan) while still guaranteeing a return of principal at the end of the time horizon. BPA is implemented by an entity hereafter referred to as “the company.”

In some aspects, in order to maximize potential client growth, BPA is designed with a 12 or 8 year Withdrawal Charge and within those time spans, a series of 4 year point-to-point indexing terms (the “Term”). However, it should be understood that other Withdrawal Charges and Terms are included in the spirit and scope of the claimed invention. In order to provide additional flexibility similar to that found in other Capital Preservation plans, BPA provides a unique early lock-in privilege which allows clients to lock-in their gains at any time during an indexing interval, for example, a four year interval, and stop any exposure to any changes in the equity index after that time. As well, this feature allows policy owners to surrender prior to the end of any Term without forgoing all earnings like all other point to point EIAs. Instead, policyholders receive a pro-rata portion of any gains in the policy at the time of surrender.

To provide additional liquidity, BPA provides a unique enhanced free partial withdrawal privilege which allows clients to receive full index gains at the time of the free withdrawal. This enhanced free withdrawal with gains is also offered for 100% withdrawal in case of confinement or terminal illness.

To round out the picture, BPA offers an enhanced minimum guaranteed death benefit rider, which guarantees that the death benefit will be no less than the original premium (also referred to as principal) accumulated with interest up to a specified age, adjusted for withdrawals. In a preferred embodiment this age is age 90, although younger ages (e.g. 85) and older ages (e.g. 95) are also included in the spirit and scope of the claimed invention.

BPA is an equity indexed single premium deferred annuity. In a preferred embodiment, issue ages are 0-85 understood that the present invention is not limited to any particular rates, multipliers, factors, etc, and that rates, multipliers, factors, etc, should be treated as variables which can change for different issue dates.

A Balanced Allocation Strategy is used to describe the interest crediting methodology. Interest is based on a blend of an equity index and a declared rate earnings. The equity index allocation is based on an equity index such as the Standard & Poor's 500 Index (S&P 500 Index) or another equity index known in the art, and the Declared Rate allocation is based on the Declared Rate which is determined at the beginning of each Term.

When the premium is paid, the company declares the Calculation Factors (also known as equity-indexed crediting parameters) for the initial Term; these factors are guaranteed for the entire Term. The Calculation Factors specify how the capital preservation concept is applied in the upcoming Term. In particular, the company declares: the Equity Indexed Allocation Percentage; the Declared Rate Allocation Percentage (together 100%); the Declared Rate; and the Asset Expense Charge Rate.

Gains accrued during the Term are credited to the Accumulation Value at the end of the Term. At that time, the sum of the declared rate earnings and equity market gain/loss participation, subject to a floor of zero on the sum, is applied to the Accumulation Value. However, at any time during the Term, clients can elect to trigger the Lock-in Date and “lock in” of their combined gains.

If the policy owner elects an early lock-in, they are immediately credited with the Index Earnings. The Index Earnings is equal to the sum of the declared rate earnings to date, and a pro-rata portion of the then-calculated equity index gain/loss, subject to a floor of zero on the sum. For the rest of the term, the policy receives Guaranteed Interest earnings which are equal to the sum of the declared rate applied to the Declared Rate Allocation, and daily installments of the remaining index gains that were not credited on the Lock-in Date. This combination is expressed as a single guaranteed interest rate that is credited from lock-in to the end of the Term. After the end of each Term, a new Term begins and the company declares new Calculation Factors (also known as equity-indexed crediting parameters) for that Term.

The Cash Surrender Value is equal to the greater of (a) the Accumulation Value adjusted for a market value adjustment (MVA) and less a Withdrawal Charge, or (b) the Minimum Guaranteed Contract Value. In a preferred embodiment, the Minimum Guaranteed Contract Value is 87.5% of the single premium less withdrawals accumulated with interest. It should be understood that other, for example higher, percentages, are within the spirit and scope of the claimed invention. The company sets the nonforfeiture interest rate for BPA in the same manner as its other EIA products.

A rider to enhance the death benefit is available for both products. It provides a guaranteed minimum death benefit equal to the premium rolled up at a specified rate. For example, rates of 5% for the 12 year design and 4% for the 8 year design. The rider premium is deducted from policy earnings at the time they are credited to the policy, but cannot exceed the earnings.

The following sample Calculation Factors (equity-indexed crediting parameters) for the first Term are used for purposes of illustration only: 40% Equity Indexed Allocation for the 12-year product and 35% for the 8-year product; 60% Declared Rate Allocation for the 12-year product and 65% for the 8-year product; and for both products, the declared rate is 1.95%. The Asset Expense Charge Rate is 0%, although other values for the Asset Expense Charge Rate are within the spirit and scope of the claimed invention.

The Term is defined as “the length of time for which interest on the Accumulation Value is calculated based on a particular set of Calculation Factors.” Each successive Term begins at the end of the immediately preceding Term, and a new set of Calculation Factors (equity-indexed crediting parameters) is declared at that time. The current design uses four-year terms, however, it should be understood that other terms are within the spirit and scope of the claimed invention. For the remainder of this discussion, a four year Term is used for purposes of illustration. However, it should be understood that the discussion is applicable to other Term lengths.

During each four year Term, the Accumulation Value stays level until the end of that Term, unless the client requests an early lock-in before the end of that Term. The starting Accumulation Value for the first Term is equal to the Premium (also referred to as principal), less any premium tax if deducted at issue. The starting Accumulation Value for the second Term equals the premium, less any withdrawals, plus any earnings credited during the first Term.

Clients can elect an early lock-in of the Index Earnings at any time during the Term. If an early lock-in is elected by the policy owner, the Index Earnings are added to the Accumulation Value at the time of the early lock-in. The Index Earnings are equal to the sum of the declared rate earnings to date, and a pro-rata portion of the then-calculated equity index gain/loss, subject to a floor of zero on that sum. From the early lock-in election until the end of the Term, the account functions like a standard fixed single premium deferred annuity (SPDA). In a standard SPDA, interest is credited daily to the policy account value at a rate declared no more frequently than annually by the carrier. Policies issued on the same day for the same amount on the same policy form would typically be credited with the same interest rate. However, the credited interest rate after lock-in for this product is determined differently from a standard SPDA: the interest rate is unique to each situation and is calculated at the time of early lock-in. During this time period, withdrawals impact the Accumulation Value in the same manner as they impact it for a standard SPDA. After the Withdrawal Charge period, the Accumulation Value grows with ongoing 4 year Terms.

BPA provides a balance of earnings consisting of a declared rate component and an equity indexed component. The allocation between the two, as well as the declared rate, is set by the company as part of the normal rate setting process. It is guaranteed for the full four year Term. New calculation factors (equity-indexed crediting parameters) are set by the company at the start of each subsequent Term (and guaranteed for that term).

The following formula is used for calculating the Index Earnings Factor and the Balanced Allocation Factor which in turn are used in the following calculations: for normal earnings crediting at the end of the four year Term if the client did not elect a lock-in during the Term; for calculating the immediate credit upon a client requested lock-in as well as calculating the interest earnings credited after lock-in; for any enhanced free partial withdrawal calculation; for any death benefit calculation; and for calculating the Balanced Allocation Value. The formula equals the sum of the combined earnings (A plus B) minus any charges (C plus D), but not less than zero. (A) is equal to the product of the following: the Equity Indexed Allocation Percentage declared at the start of the Term; the change in the equity index (measured by comparing the index value on the start of the Term to the Ending Index Value, defined below, on the Lock-in Date); and the Pro-Rata Factor for that date, as defined below. (B) is equal to the product of the following: the Declared Rate Allocation Percentage declared at the start of the Term; and the Declared Rate compounded from the start of the Term to the Lock-in Date, for example, (1+0.0195)^{t}−1 where t is the Elapsed Term. (C) is equal to the product of the following: the annual percentage cost of any rider attached to the policy; and the elapsed time in the current Term. The elapsed time used to calculate the rider charge is expressed in years with a fraction for partial years. The elapsed time used to calculate the rider charge is the lesser of (a) the Elapsed Term or (b) the rider elapsed time from the start of the Term to Rider Premium Completion Date. (D) is equal to the product of the following: the Asset Expense Charge Rate declared at the start of the Term; and the Elapsed Term.

In the formula in the preceding paragraph, item A is allowed to be negative. However, the total value (A+B−C−D) is never allowed to be less than zero. For this calculation, the Equity Indexed Ending Value is defined as follows: at the end of the Term, the Equity Index Ending Value is the average of the equity index values published during the last 30 calendar days of the Term. Note that the use of a different number of days in the averaging period (e.g. 1, 15, 45, or 90 days) is within the spirit and scope of the claimed invention.

On any other date during a term (the date of death, for determining the Balanced Allocation Value, or upon lock-in prior to the end of the Term), the Equity Index Ending Value is equal to the equity index value on that day (or if the index is not published that day then the most recently published index value).

The only difference between the Index Earnings Factor and the Balanced Allocation Factor is the way that the Pro-rata factor is defined in item A above: in calculating the Index Earnings Factor, the Pro-Rata Factor is the time since the start of the term divided by the total length of the term. The measurement of time is in actual days gone divided by actual days in the term (i.e. taking leap years into account). In calculating the Balanced Allocation Factor, the Pro-rata factor is set equal to one. At lock-in the Balanced Allocation Factor is set equal to zero. This enables use of the same FPW formula after lock-in.

The Balanced Allocation Factor and the Balanced Allocation Value are terms defined in the policy form to help explain earnings, FPW and death benefit calculations. The Balanced Allocation Value is included on each anniversary statement and thus provides the policy holder lock-in information as of the last policy anniversary.

The Balanced Allocation Value is equal to the Accumulation Value times the Balanced Allocation Factor. This definition results in the following values being used in the formula described above.

| | |
|---|---|
| Lock-in Date | The date for which the Balanced Allocation Value is |
| | being calculated |
| Elapsed Term | The time elapsed from the start of the current index |
| | term to the Lock-in Date. The elapsed time is |
| | expressed as years with fractional amounts |
| Pro-Rata Factor | One |
| Equity Index | The equity index value published on the date for |
| Ending Value | which the Balanced Allocation Value is being |
| | calculated. We do not anticipate calculating the |
| | Balanced Allocation Value at the end of the term. If |
| | it is calculated at that point then use the average of |
| | the index values published during the last 30 days. |

If lock-in is not elected during an Term, then at the end of the Term the combined earnings equal the Accumulation Value at the end of the term times the Index Earnings Factor. This definition results in the following values being used in the formula described above.

| | |
|---|---|
| Lock-in Date | Policy anniversary at the end of the Term |
| Elapsed Term | Four years |
| Pro-Rata Factor | One |
| Equity Index | Average of the index values published during the |
| Ending Value | last 30 calendar days of the term |

In the situation where the client elects to lock in their gains during the Term, the interest credited to the Accumulation Value is equal to: first, the Index Earnings which are credited immediately on the Lock-in Date; and second, the guaranteed interest rate (g) credited from the Lock-in Date until the end of the Term.

The immediate credit is equal to the Accumulation Value on the early lock-in date times the Index Earnings Factor. This definition results in the following values being used in the formula described above.

| | |
|---|---|
| Lock-in Date | The date the owner's lock-in request was received in |
| | good order at home office |
| Elapsed Term | The time elapsed from the start of the current index |
| (for use in | term to the Lock-in Date. The elapsed time is |
| calculating | expressed as years with fractional amounts |
| pro-rata factor | |
| and items B, | |
| C and D] | |
| Pro-Rata Factor | The Elapsed Term divided by four |
| Equity Index | The equity index value published on the Lock-in |
| Ending Value | Date |

Between the lock-in date and the end of the Term, the Accumulation Value acts like a regular SPDA and earns daily interest at the “guaranteed rate” “g.” The guaranteed rate is calculated at the time of lock-in and is guaranteed for the remainder of the Term. This guaranteed rate g will in general be different for each policy that elects to lock-in because the change in the equity index from the start of the Term to the time of lock-in will vary daily.

The guaranteed rate is determined so that at the end of the Term, the Accumulation Value is equal to a target accumulation value. From a marketing viewpoint, this target accumulation value can be thought of as: the Accumulation Value immediately prior to lock-in, plus the equity indexed allocation earnings (without any pro-rata adjustment) calculated at lock-in, plus declared rate allocation earnings for the entire Term, minus any rider charges or asset expense charges.

This target accumulation value is equal to the Accumulation Value immediately prior to lock-in times the quantity (1 plus the Index Earnings Factor) with the following values in the formula described above.

| | |
|---|---|
| Lock-in Date | The date the owner's lock-in request was received in |
| | good order at home office |
| Elapsed Term | Four years |
| Pro-Rata Factor | One |
| Equity Index | The equity index value published on the Lock-in |
| Ending Value | Date |

The guaranteed rate, g, is solved such that the following formulas provide the same result. In the formula below t is the time of lock-in, and items A, B, C and D are as defined above. A is the equity indexed allocation earnings calculated at the time indicated and using the appropriate pro-rata factor for that time; B is the declared rate allocation earnings; C is the rider premium charge; D is the Asset Expense Charge; and RT is the time remaining in the Term.

The following two formulas must have the same value:

(AVₜ×(1+Aₜ+B_{end of term}−C_{end of term}−D_{end of term}))

(AVₜ×(1+Aₜ+Bₜ−Cₜ−Dₜ))×(1+g)^{RT}

Therefore g is equal to:

g=[(1+Aₜ+B_{end of term}−C_{end of term}−D_{end of term})/(1+Aₜ+Bₜ−Cₜ−Dₜ)]^{(1/RT)}−1

Note that the annual rider premium is multiplied by the elapsed time indicated in the formula. This time period has to be tested such that it does not exceed the Rider Premium Completion Date as described above.

At the time of an early lock-in, the client receives a confirmation statement informing them of their guaranteed rate for the rest of the term. This confirmation includes at least the following items: amount of earnings credited to the Accumulation Value on the lock-in date, resulting new Accumulation Value, Interest rate for the remainder of the term. A confirmation that includes more information and follows the layout of the annual statement can also be sent and is within the spirit and scope of the claimed invention.

The table below summarizes the various values described above.

| | Equity Index Ending | Elapsed Term (used for | Prorata Factor (used for |
|---|---|---|---|
| | Value (used for A) | B, C and D) | A) |
| At Term End if no | | | |
| prior lock-in | | | |
| For use in Index | Average of equity index | Defined as Actual | Defined as Elapsed |
| Earnings Factor | values on business days | number of years | Term/4 |
| | during last 30 days | including fractions | At the end of term this |
| | | between term start and | will be 1 for the current |
| | | Lock-in Date | designs |
| | | At the end of term this | |
| | | will be 4 years for the | |
| | | current designs | |
| For use in Balanced | Balanced Allocation | N/A | N/A |
| Allocation Factor | Factor equals 0 | | |
| On any other date | | | |
| “D” if no prior lock-in | | | |
| For use in Index | equity index value for | Defined as Actual | Defined as Elapsed |
| Earnings Factor | date “D” | number of years | Term divided by the |
| | | including fractions | total term (4 years for |
| | | between term start and | the current design) |
| | | Lock-in Date | |
| For use in Balanced | equity index value for | Defined as actual | Defined to be 1 |
| Allocation Factor | date “D” | number of years | |
| | | including fractions | |
| | | between term start and | |
| | | Lock-in Date | |
| For use in end-of-term | equity index value for | Defined to be the | Defined to be 1 |
| index earnings factor | date “D” | number of years of the | |
| (this is used in | | term. This is 4 years | |
| calculation of g) | | for the current design | |
| On any other date if | | | |
| prior lock-in | | | |
| For use in Balanced | Balanced Allocation | | |
| Allocation Factor | Factor equals 0 | | |
| For use in Index | Index Earnings Factor | | |
| Earnings Factor | not used | | |

After the end of the Withdrawal Charge period, the four year Terms continue. The policy form allows for expense charges. The initial product has expense charges set to zero for all Terms. An example of the equity index used in this product is the S&P 500 Composite Price Index. The policy form provides the flexibility of using a different index.

The index value used on any given policy anniversary will be the value of the index on the close of business on that date. If the policy anniversary falls on a day that the index is not published (weekend or holiday) then the most recently published index value will be used.

Note that the lock-in provision can be triggered by the client on any date. Thus, the system references the index value on dates other than policy anniversaries. If the home office processing date falls on a date that the index is not published then the most recently published index value will be used.

The percentage change of the equity index is measured by comparing the equity index at the start of the Term to the Equity Index Ending Value. At the end of the Term, the Equity Index Ending Value is the average of the equity index values published during the last 30 calendar days of the Term.

On any other date (i.e. for death benefits, for determining the Balanced Allocation Value, or upon lock-in prior to the end of the Term), the Equity Index Ending Value is equal to the equity index value on that day (or if the index is not published that day then the most recently published index value).

Note that the percentage change can be a negative number. Thus, equity indexed allocation earnings can erode any declared rate allocation earnings but they can not erode principal since the combined earnings can never be less than zero.

In each policy year (including the first), there is no Withdrawal Charge or Market Value Adjustment on partial withdrawals up to a specified percentage of the Accumulation Value as of the first partial withdrawal, or the RMD (required minimum distribution if qualified). For purposes of illustration, 10% is used in the following discussion. The cumulative enhanced free partial withdrawal limit L for the current policy year equals 10% of the Accumulation Value at the beginning of the current policy year plus the sum, for all previous policy years, of the lesser of a) 10% times the Accumulation Value at the beginning of that policy year, and b) the amount actually withdrawn during that policy year. If cumulative withdrawals to date do not exceed the cumulative enhanced free partial withdrawal limit to date then all such withdrawals are “enhanced free partial withdrawals” as described below.

Typical EIA products penalize policy owners who take free partial withdrawals (FPWs) other than on an index crediting anniversary. Under those designs, intra-term free partial withdrawals do not participate in any index earnings. BPA includes the innovative concept of Enhanced Free Partial Withdrawals (EFPW), i.e. including earnings to date for any FPW. This concept applies before lock-in. After lock-in the withdrawal is processed like any other normal SPDA.

If the FPW is before lock-in, the Balanced Allocation Factor is calculated on the withdrawal date. This factor, as described above, is the gain to date for the combined declared rate allocation earnings and indexed allocation earnings.

The amount deducted from the Accumulation Value on an enhanced free partial withdrawal is the FPW amount paid to the client divided by the growth-to-date factor G, which equals one plus the Balanced Allocation Factor. Since one plus the Balanced Allocation Factor is always greater than or equal to one, the amount withdrawn from the Accumulation Value will always be less than or equal to the FPW amount received by the client, i.e. the withdrawal will be no more than dollar-for-dollar.

The FPW limit is 10% of the Accumulation Value at the time of the first withdrawal during the year. This is a change from standard company practice of using 10% of the Accumulation Value at the previous anniversary. If a client locks in and receives an index credit part way through a year, the free withdrawal limit is 10% of the Accumulation Value at that time, including that index credit. For example, suppose the premium (principal) is 10,000 at issue and the client locks in after 2½ years and the Accumulation Value grows to 15,000. If the client makes a free withdrawal at that time, the free withdrawal amount is 10% of 15,000 and not 10% of the year-start value of 10,000.

Note that after lock-in, the free withdrawal amount requested equals the amount withdrawn from the Accumulation Value. Any withdrawal in excess of the FPW does not include any gains to date calculation (i.e. the account value is reduced dollar-for-dollar, prior to any MVA calculation) and does include a deduction for Withdrawal Charges and a market value adjustment. Note that (a) free partial withdrawals are available in the first policy year, and (b) the policy form currently does not impose any limit on the number of withdrawals. It simply defines the minimum withdrawal to be $300 (this is the amount withdrawn from the Accumulation Value not the amount received—see discussion above). Systematic withdrawals are typically limited to monthly electronic funds transfer although other withdrawal options are within the spirit and scope of the claimed invention.

The policy allows a free partial withdrawal of the entire Accumulation Value when the annuitant is confined to a care facility or upon his or her terminal illness, although a free partial withdrawal of less than the entire Accumulation Value is within the spirit and scope of the claimed invention. Withdrawals under the terminal illness or confinement waivers are treated as free partial withdrawals and thus receive the same treatment as other free withdrawals, namely: surrender charges and the Market Value Adjustment (MVA) will be waived; if the withdrawal occurs before the lock-in date, the amount deducted from the Accumulation Value equals the amount paid to the policyholder divided by 1+Balanced Allocation Factor, i.e. divided by the growth-to-date factor.

The Cash Surrender Value is the greater of (a) the Minimum Guaranteed Contract Value and (b) the Accumulation Value modified by the market value adjustment less a Withdrawal Charge. However, the Withdrawal Charge and MVA are waived on payments to the client equal to up to 10% of the Accumulation Value surrendered each year. Up to this limit, the amount withdrawn from the Accumulation Value is less than the amount paid to the client. For any withdrawals in excess of that amount there is a Withdrawal Charge and MVA.

In a preferred embodiment of the 12-year design, the Withdrawal Charge scale is: 13.5, 13, 12.5, 12, 11, 10, 9, 8, 7, 6, 5, 3, 0% of the amount withdrawn in excess of the free withdrawal amount, although a higher Withdrawal Charge scale starting at (e.g.) 15% or a lower Withdrawal Charge scale starting at (e.g.) 10% is within the spirit and scope of the claimed invention.

In a preferred embodiment of the 8-year design, the Withdrawal Charge scale is: 10, 9, 8, 7, 6, 5, 4, 3, 0% of amount withdrawn in excess of the free withdrawal amount, although a higher Withdrawal Charge scale starting at (e.g.) 12% or a lower Withdrawal Charge scale starting at (e.g.) 5% is within the spirit and scope of the claimed invention.

If a client does a full surrender before lock-in, the company locks-in the policy before proceeding with the surrender. This raises the question of whether the enhanced free partial withdrawal (EFPW) should be done before or after lock-in. Depending on the change in the equity index, either method can generate better results. Typically, to ensure the best possible result for the client, the calculation should be done on both methods and the better method selected for the respective request, although use of a fixed order of calculation is within the spirit and scope of the claimed invention.

The policy will include a modification from normal company practice for confinement and terminal illness. The normal company definition will be used. However, 100% of the Accumulation Value can be depleted without any Withdrawal Charge or MVA. Note that this means, assuming no prior lock-in, that if the client withdraws all available funds, the cash received will equal 100% of the Balanced Allocation Value.

A market value adjustment (MVA) applies on surrenders in excess of the free partial withdrawal limit. It does not apply to the Minimum Guaranteed Contract Value. The formula is described below.

The MVA is calculated as follows: 50%×(a−b)×n/12
“a” is the 10-year Treasury Rate at issue.
“b” is the 10-year Treasury Rate published on the day before the surrender or withdrawal is processed plus 0.25%
“n” is the number of complete contract months remaining until the end of the withdrawal charge period. Any positive MVA cannot exceed the Withdrawal Charge.
   Any negative MVA cannot exceed the interest paid to date.

The Minimum Guaranteed Contract Value is a secondary guarantee that defines the minimum Cash Surrender Value and death benefit for the policy. In a preferred embodiment, the initial Minimum Guaranteed Contract Value is 87.5% of the single premium (principal). However, it should be understood that other percentages are possible. The Minimum Guaranteed Contract Value is accumulated at the minimum guaranteed Interest Rate. This rate is set at issue to satisfy the nonforfeiture law the same way as it is set for the equity indexed buckets on other EIA products.

Any partial withdrawals reduce the Minimum Guaranteed Contract Value by the amount paid to the policyholder. Note that the deduction is the “amount paid”; this can be different from the amount deducted from the Accumulation Value in many ways: for free withdrawals, the deduction from Accumulation Value is always less than or equal to the amount paid to the policyholder as described above.

For non-free withdrawals, the amount paid is equal to the amount deducted from the Accumulation Value, less any Withdrawal Charges and after applying any MVAs (i.e. the amount paid is reduced by any negative MVAs and increased by any positive MVAs). There is no top-up of the Minimum Guaranteed Contract Value.

The initial Accumulation Value is the single premium (principal). In a preferred embodiment, any applicable state premium taxes at issue are not deducted, although deducting state premium taxes at issue is within the spirit and scope of the claimed invention. The Accumulation Value earns interest as described previously.

The Accumulation Value is decreased by any partial surrenders, including any applicable Withdrawal Charges and MVA. However, in the case of a free withdrawal, the decrease in the Accumulation Value is less than the amount paid to the client, as described above.

As with typical current policies, the death benefit is paid upon receipt of proof of death of the annuitant. The death benefit is the greatest of (a) the Cash Surrender Value reflecting any market value adjustment, and (b) the Balanced Allocation Value ignoring any Withdrawal Charge or market value adjustment, as of the date of receipt of proof of death.

The policy follows current company practice. The death benefit is paid on the death of the annuitant. If the beneficiary of the death benefit is a spouse of the annuitant then no death benefit is paid and the spouse continues the policy.

This rider can be elected by the policy owner at issue. The rider can not be dropped once elected. On death of the annuitant, the beneficiary receives the greater of actual death benefit under the annuity and the Enhanced Guaranteed Minimum Death Benefit. The enhanced death benefit is equal to the premium accumulated at an interest rate that is set at issue. The premium is accumulated at that interest rate until the Completion Date, and it is adjusted for any withdrawals. This type of death benefit rider is normally found with variable annuity (VA) products and is generally referred to as a Rollup Death Benefit.

At issue, the enhanced death benefit is equal to the premium paid. Thereafter it increases at the stated interest rate until the completion date. In a preferred embodiment, values for the rollup interest rate are 4% for the 8 year design and 5% for the 12 year design. However, it should be understood that the rates are subject to change, and that other values for the rollup interest rate are within the spirit and scope of the claimed invention. In a preferred embodiment, the roll up completion date is the policy anniversary following the annuitant's 90th birthday. However, it should be understood that other completion dates are possible. Although the death benefit stops increasing after the completion date, it is still paid out after that date if it is higher than the regular annuity death benefit at the date of death.

The rider premium is guaranteed at the rate set at issue. In a preferred embodiment, the rate is 0.50% per year. However, it should be understood that the rate is subject to change, and that other values for the rider premium are within the spirit and scope of the claimed invention. The rider premium is payable until the completion date (the policy anniversary following the annuitant's 90th birthday). The premium is charged at the same time that interest is credited to the Accumulation Value. The rider premium can not exceed the amount of interest credited; therefore any portion of the rider premium in excess of the amount of interest credit will be waived. The treatment of rider premiums is contained in the formulas for the Indexed Earnings factor and the Balanced Allocation Factor described above. A text explanation and example of those formulas is as follows: if a client does not elect lock-in during a Term, then at the end of the Term, the interest credit is reduced by the Accumulation Value times 0.50% multiplied by the lesser of (a) the number of years in the Term or (b) the number of years between the start of the Term and the Rider Premium Completion Date. However, the resulting credit cannot be less than zero.

If a client elects lock-in during a Term, then at that time, the resulting credit is reduced by 0.50% times the lesser of (a) the number of full years plus a fraction for the partial year since the start of the Term and (b) the time between the start of the Term and the Rider Premium Completion Date. At lock-in the guaranteed rate g is calculated as described previously. The formula for this rate automatically adjusts for any outstanding rider premiums.

The Enhanced Death Benefit is adjusted for any withdrawals. At the time a withdrawal is made, it is multiplied by an adjustment factor equal to (a) divided by (b) where: (a) is the Accumulation Value immediately after the partial withdrawal and (b) is the Accumulation Value immediately prior to the partial withdrawal.

The policy includes the usual “persons” found within a deferred annuity contract. The contract is annuitant driven not owner driven. This includes: (a) Annuitant—the life that is being used to measure the starting date of annuity income payments; the death benefit is paid on the death of the annuitant; Joint Annuitants are permitted; the Annuitant(s) can not be changed after issue. (b) Payee—the person to receive the annuity income—this is always be the annuitant. (c) Owner—there may be multiple owners (primary, secondary, joint). (d) Beneficiary—there may be multiple beneficiaries (primary, secondary, multiple).

The minimum age is zero. The maximum issue age for the annuitant will be age 85 for the policy with an 8 year Withdrawal Charge period and age 80 for the policy with a 12 year Withdrawal Charge period, although other values for the maximum issue age are within the spirit and scope of the claimed invention. If the age or sex of the annuitant is misstated, then at annuitization, the annuity payments will be adjusted to what they should have been had the correct age and/or sex had been used.

The free look period varies by state and follows normal company practice. In most situations, the policy may be returned within 10 days after delivery of the policy. All premiums paid, less any partial surrenders, are refunded without penalty.

Policies are issued on a daily basis. In a preferred embodiment, the Issue Date is two working days after the date that the premium is paid, although other intervals between the payment of premium and the Issue Date are within the spirit and scope of the claimed invention. For 1035 exchange policies, this is the date that the last funds are received at home office. The Issue Date does not have to be a date that the New York Stock Exchange (NYSE) is open (see above).

The starting equity index value for 1035 exchange policies is the date funds are received. Normal rate guarantee procedures apply for this product. The rate guarantee time period varies and is published with any new rate announcement. The rate guarantee applies from the date the application was signed. That means, for up to a particular number of days (as specified on the rate sheet), the allocation and the declared rate are the higher of the rates in effect (as) the date the application was signed or (b) the date funds were received at home office.

Shortly after each policy anniversary, an annual statement is sent to the policy owner.

This is a single premium plan. There are no further premiums allowed. The premium paid is also referred to as the principal. In a preferred embodiment, the minimum premium is $5,000 for non-tax-qualified policies and $2,000 for tax-qualified policies. The maximum single premium is $1,000,000 (without prior Home Office approval). Different values for the minimum and maximum single premiums are within the spirit and scope of the claimed invention.

Between anniversaries, the system provides the following information: whether the client has elected an early lock-in for that Term; current declared rate in effect (only if prior to early lock-in); current guaranteed rate in effect (only if after early lock-in); current equity index value and the equity index at the start of the current Term; current Balanced Allocation Value; if prior to early lock-in, the information on how all the components were calculated also is available in case a client wants to walk through the calculation; current Accumulation Value; the Account Value if the client locked in today, and the resulting Cash Surrender Value; end of term Accumulation Value if locked in today; and, maximum Free Partial Withdrawal amount available and the amount that will be deducted from the Accumulation Value for that withdrawal. Depending on systems capabilities, information may be available on-line or by telephone access to policy owners, or may be limited to the company's client service staff. The policy terminates at the earliest of: full surrender, death (unless continued by a surviving spouse), or maturity.

The Cash Surrender Value is the Accumulation Value less the Withdrawal Charge and modified by the MVA, but it is never lower than the Minimum Guaranteed Contract Value. If the policy has not been locked-in prior to surrender then a lock-in should be automatically triggered. The order of processing is described in more detail above.

Normal company practices apply as to whether a beneficiary has the right to continue the policy on the death of the owner of the annuitant. Normal current company practice apply for benefits paid upon the death of the owner. The death benefit for the annuitant is greatest of: Balanced Allocation Value or Cash Surrender Value.

The annuitant must commence receiving income payments if the Contract is in force on the Annuity Date. The Annuity Date is correlated to an age for an annuitant. For example, in a preferred embodiment, the Annuity Date equals the anniversary immediately after the oldest annuitant's 100th birthday. However, it should be understood that other ages are included in the spirit and scope of the claimed invention. The annuity value is the Cash Surrender Value. If the client has not yet elected an early lock-in for the current term, a lock-in is processed prior to annuitizing. Alternatively, the client can apply their Cash Surrender Value at any time to purchase an immediate annuity under the basis guaranteed in the contract. The company waives Withdrawal Charges and MVA according to normal company practices: for example, in years 2-5 the SPIA must be for 8 years or longer; in years 6+ the SPIA must be for 5 years or longer.

The policy includes company standard language for qualifying for the waiver of Withdrawal Charges and MVA upon confinement or terminal illness. The percentage payout has been increased such that the client can deplete 100% of the Accumulation Value without incurring any Withdrawal Charges or MVA. Any withdrawal under either waiver is processed just like a normal free partial withdrawal (i.e. it includes gains to date as described above). That means the client receives 100% of the Balanced Allocation Value if they deplete 100% of the Accumulation Value. The waiver is now available at all ages.

Once sales volumes are sufficient, a PC based “Hedge Inventory System” customized for the BPA design will be delivered to the carrier. This may be used by the investment division to monitor and manage the investment hedge relative to the product liability (the promises made to the product's policy holders). If the investment division decide to use this system then the following two new data feeds are required: Policy Administration Feed: feeds relevant rate information on each policy; this includes: specified rate table, term, issue date; and Investment Hedge Feed: feeds relevant information on the hedges purchased/sold for each block of business.

These feeds are not required for the initial product launch since a certain asset volume is required before the Hedge Inventory System becomes useful. This description only describes these new data feeds without mentioning the normal data feeds expected from and to the policy administration system.

The record layout below deals only with the policy administration feed. This involves a higher volume and requires automation. The investment feed depends on what hedging strategy is implemented. It also involves a much lower volume and in the past has been handled via a simple spreadsheet input. Thus, the definition and implementation can be delayed until volume requires a formal solution. One record is required per policy that is still within the Initial Term (and therefore indexed). All fields should be based on current values as of the date that the file is created from the administration system.

Input is freeform with fields separated by blanks or tabs. If it is possible for the data to be uniform (columnar) then this would be preferable, but not essential, for ease of input into the hedging system. The fields listed below are examples of the fields that will be required. The actual fields will be determined once the customization process begins. (1) Product Type—this is a character code, such as BPA, identifying the product type. Whichever code is used internally by the administrative system can be used here. (2) Policy Number—this is an integer, such as Ser. No. 12/345,678, to uniquely identify the policy. (3) Starting Accumulation Value—this is a dollars and cents amount, such as 120000.00, which is the amount originally paid for the policy. (4) Date of Issue—this is the date in YYYYMMDD format, such as 20030131, that the policy was issued. (5) Maturity Date—this is the date in YYYYMMDD format, such as 20330131, that an income is assumed to be paid under the terms of the policy. For this design it is age 95 of the annuitant. (6) Owner Sex #1—this is a single letter, one of M, F, or N (male, female, not a natural person) indicating the sex of owner #1 of the policy. This data may be required for calculation of the expected indexed interest credit on death. (7) Owner DOB #1—this is the date in YYYYMMDD format, such as Ser. No. 19/391,015, that owner #1 of the policy was born. (8) Owner Sex #2—this is a single letter, one of M, F, or N (male, female, not a natural person) indicating the sex of owner #1 of the policy. (9) Owner DOB #2—this is the date in YYYYMMDD format, such as Ser. No. 19/391,015, that owner #2 of the policy was born. (10) Annuitant Sex #1—this is a single letter, one of M, F, or N (male, female, not a natural person) indicating the sex of Annuitant #1 of the policy. This data may be required for calculation of the expected indexed interest credit on death. (11) Annuitant DOB #1—this is the date in YYYYMMDD format, such as Ser. No. 19/391,015, that Annuitant #1 of the policy was born. (12) Annuitant Sex #2—this is a single letter, one of M, F, or N (male, female, not a natural person) indicating the sex of Annuitant #1 of the policy. (13) Annuitant DOB #2—this is the date in YYYYMMDD format, such as Ser. No. 19/391,015, that Annuitant #2 of the policy was born. (14) Term Period—this is an integer, such as 48, indicating the number of months in each term. (15) Index Type—this is a five character code, such as SP500 or NASDQ, identifying the outside index to which the performance of the policy is tied. (16) Current Calculation Factors—the Calculation Factors (equity-indexed crediting parameters) for the current Term. (17) Minimum Calculation Factors—separate factors are needed for the second Term and the third Term. For each of these terms, the feed must show the guaranteed equity allocation percentage, and the guaranteed declared rate. (18) Surrender Scale—this is a six character code, such as DECL06, identifying the Withdrawal Charge scale used for the policy. (19) Maximum Annual FPW Rate—this is a percentage, such as 10.00, indicating the maximum annual free partial withdrawal rate under the policy. (20) Last Update—this is the date in YYYYMMDD format, such as 20030131, when the values included in the extract file were last updated. It may be convenient for valuation dates to coincide with update dates. (21) Index Value at Policy Issue—this is the value of the equity index, such as 850.00, that was in effect on the Date of Issue. (22) Minimum Guaranteed Contract Value at Issue—this is a dollars and cents amount, such as 108000.00, which is the Minimum Guaranteed Contract Value at issue. (23) Minimum Guaranteed Contract Value Interest Rate. This is the minimum guaranteed interest rate percentage to be credited to the Minimum Guaranteed Contract Value. (24) Accumulation Value at Start of Most Recent Policy Year—this is a dollars and cents amount, such as 120000.00, which is the Accumulation Value at the start of the most recent policy year. (25) Minimum Guaranteed Contract Value at Start of Most Recent Policy Year—this is a dollars and cents amount, such as 108000.00, which is the Minimum Guaranteed Contract Value at the start of the most recent policy year. (26) Index at Start of Most Recent Policy Year—this is the value of the equity index, such as 850.00, that was in effect at the start of the most recent policy year. (27) Total Interest Credited—this is a dollar and cents amount, such as 10000.00, which is the total amount of interest ever credited to the policy. (28) Total Credits to the Minimum Guaranteed Contract Value—this is a dollar and cents amount, such as 10000.00, which is the total interest ever credited to the Minimum Guaranteed Contract Value. (29) Total FPW Deducted—this is a dollar and cents amount, such as 5000.00, which is the total amount of free partial withdrawals that have been deducted from the Accumulation Value.

At the start of each Term, the accumulation value is given an equity indexed allocation and a Declared Rate allocation declared by the company. The equity allocation has 100% participation in the equity index until the earlier of the lock-in date or the end of initial term, while the Declared Rate allocation participates in declared rate crediting. The client can request a lock-in once in each term. In each term, there is no credit until the earlier of the end of the term, or the date that the client requests a lock-in. If the client does not request a lock-in, then at the end of the term, they receive the combined total of 100% of the gain or loss in the equity index applied on the equity allocation, plus the compounded declared rate earnings on the Declared Rate allocation, subject to a floor of zero. If client requests a lock-in prior to the end of the term, then at that time, the accumulation value receives a pro-rata portion of the gain on the equity allocation, plus the compounded declared rate earnings to date on the Declared Rate allocation. The accumulation value then earns guaranteed interest for the remainder of the term, using a rate determined at lock-in, as described below.

An example of the Stock Index that can be used in this product is the S&P 500 Composite Price Index (does not include dividends). It should be understood that another index, such as the Russell 2000 or the Nasdaq 100 can be used and that the use of these other indexes is within the spirit and scope of the claimed invention. The Percentage Increase in the equity index is calculated by comparing the Equity Index Ending Value for the lock-in date to the equity index at the start of the term. At the end of the term, the Equity Index Ending Value is the average of the equity index values during all business days during the last 30 calendar days of the term. On the date of death or lock-in prior to the end of the term, the Equity Index Ending Value is equal to the equity index on that day (or if that day not a business day, then on the previous business day).

The Calculation Factors (equity-indexed crediting parameters) for each term are set by the company at the start of that term, and are guaranteed for the entire term. The Calculation Factors are: the Equity Indexed Allocation; the Declared Rate Allocation (equal to 100% minus the Equity Allocation); the Declared rate; and, the Asset Expense Charge Rate (currently 0).

Equity Indexed Allocation is the proportion of the accumulation value for which earnings depend on the performance of the equity index up to end of the term, or the lock-in date if earlier. Pricing solves for a combination of Declared Rate allocation and equity indexed allocation that the company can credit while achieving target profitability. Declared Rate Allocation is the proportion of the accumulation value for which earnings depend on the declared rate. The rate applied to the Declared Rate allocation

For each future term which begins prior to the end of the surrender charge period, the following minimum Renewal Calculation Factors (equity-indexed crediting parameters) are guaranteed (percentages are for purposes of illustration only): Equity Allocation: 20%; Declared rate: 1.5% for 12-year design, 1% for 8-year design. The Asset Expense Charge Rate is the same level as at issue.

Once in each term, the client can elect to “lock in” indexed gains at any time during that term. After the lock-in, the Accumulation Value earns daily interest for the rest of the term. In determining the amount of interest to be credited, we define the following for time t, where t is the time since the start of the term: AVₜ is the Accumulation Value at time t, prior to any index credits. At is the Equity-Related Earnings, and is equal to: the equity allocation percentage; times the percentage increase in the equity index (as defined above) at time t; times the pro-rata factor for time t. Bₜ is Declared Rate Earnings, and is equal to: the Declared Rate allocation percentage; times (1+Declared rate)^{t}−1. Cₜ is the Death Benefit Rider Premium, and is equal to: the total annual premium rate for any riders attached to this policy; times the number of years in the Elapsed Term for that date, or if less, the number of years between the start of the Term, and the Rider Premium Completion Date. Dₜ is the Asset Expense Charge, and is equal to: the asset expense charge rate; times the number of years in the Elapsed Term for that date.

At any time t, the Index Earnings Factor equals the sum of: Aₜ plus Bₜ minus Cₜ minus Dₜ. The pro-rata factor used in item A is defined to be: the elapsed days since the start of the initial term; divided by the total days in the initial term.

At any time t, if lock-in for the current term is not elected, the Balanced Allocation Factor equals the sum of: Aₜ plus Bₜ minus Cₜ minus Dₜ. It is the same as the Index earnings factor except that the pro-rata factor is defined to be 1. If lock-in is elected, the Balanced Allocation Factor is zero.

If no lock-in, the Accumulation Value receives interest at the end of the term equal to the Accumulation Value times the combined equity indexed gain or loss on the equity-allocation, and declared rate earnings on the Declared Rate allocation. The formula for the index credit is: AV_{end of term} times the Index earnings factor: in the special case where the index credit is paid at the end of the term, the pro-rata factor is 1, and the elapsed term is 4 years, and the Index earnings factor equals the sum of: A_{end of term} plus B_{end of term} minus C_{end of term} minus D_{end of term}. The factor is not less than zero.

If lock-in at time t, the equity index gains are locked in on the equity allocation, and the accumulation value receives interest credited immediately based on a pro-rata share of the equity index gains as well as all declared rate earnings accrued to date on the declared rate portion. The formula is: AVₜ times the Index earnings factor, where the Index earnings factor equals the sum of: Aₜ plus Bₜ minus Cₜ minus Dₜ.

Between the lock-in date and the end of the initial term, the accumulation value acts like a regular SPDA and earns daily interest at the “guaranteed rate”. The guaranteed rate is calculated at the time of lock-in and is guaranteed for the remainder of the term. The guaranteed rate is determined so that at the end of the term, the accumulation value equals the accumulation value immediately prior to lock-in, plus the equity related earnings (without any pro-rata adjustment) calculated at lock-in, plus declared rate earnings for the entire term.

The guaranteed rate, g, is solved such that the following formulas provide the same result, where RT is the time remaining in the term.

(AVₜ×(1+A_{end of term}+B_{end of term}−C_{end of term}−D_{end of term}))

(AVₜ×(1+Aₜ+Bₜ−Cₜ−Dₜ))×(1+g)^{RT}

Therefore g is equal to:

[(1+A_{end of term}+B_{end of term}−C_{end of term}−D_{end of term})/(1+Aₜ+Bₜ−Ct−Dₜ)]^{(1/RT)}−1

In all cases, the pro-rata factor used in calculation A equals the elapsed days since the start of the initial term, divided by the total days in the initial term.

The Accumulation value at any times is equal to: the Accumulation value at start of term (or the premium at the start of the first term), less withdrawals plus earnings. Before lock-in there are no increases to the Accumulation value for that term. If a client selects to lock-in, for that term, there is an immediate earnings credit to the Accumulation value on the lock-in date. After lock-in, the Accumulation value earns daily interest for the remainder of that term (see description of lock-in for formulas). If there is no lock-in for a term, then the Accumulation value receives one lump sum earnings credit at the end of that term.

The Cash Surrender Value is the greater of: Accumulation Value less surrender charge adjusted by market value adjustment (MVA); and Minimum Guaranteed Contract Value (with no MVA). The Minimum Guaranteed Contract Value is: 87.5% of the single premium (principal) less withdrawals, all accumulated at X % interest, where X is set to satisfy the new nonforfeiture law, and any marketing concerns. There is no Market Value Adjustment applied to the Minimum guaranteed value.

In a preferred embodiment, the Withdrawal Charge is: 12-year design: 13.5/13/12.5/12/11/10/9/8/7/6/5/3/0% of amount withdrawn in excess of the free withdrawal amount. In a preferred embodiment, 8-year design: 10/9/8/7/6/5/4/3% of amount withdrawn in excess of the free withdrawal amount. It should be understood that other percentages are included within the spirit and scope of the claimed invention.

The market value applies during the Surrender Charge Period only. It is applied to the surrender value or partial withdrawal amount. However, it is not applied to free withdrawals. It is not applied to the Minimum Guaranteed Contract Value. In general, the regular MVA formula is followed, except that there is no component related to the Accumulation Value Floor.

In a preferred embodiment, the MVA is calculated as follows:

50%×(a−b−0.25%)×n/12
where:
   “a” is the 10-year Treasury Rate at the start of the term.
   “b” is the 10-year Treasury Rate on the calculation date.
   “n” is the number of months remaining before the expiration of the surrender charge period.

A positive MVA cannot exceed the surrender charge. A negative MVA cannot exceed the lifetime investment income to date.

In any policy year, the amount of cash received under a free withdrawal is limited to a specified percentage, for example 10%, of the Accumulation Value at the time of the first withdrawal in a year. Standard industry practice is to use 10% of the accumulation value at the start of each year. BPA changes to the time of the first withdrawal, so that if a client locks in part way through a year and receive index credits, they can then access 10% of the accumulation value including those index credits.

The amount deducted from the accumulation value to pay for a free partial withdrawal equals the actual cash payment, divided by the growth-to-date factor, which equals (1+Balanced Allocation Factor at time t). In other words, if the client makes a free partial withdrawal prior to lock-in, the client receives the full in force gain on the amount deducted from the accumulation value.

As is standard industry practice, there are also free partial withdrawals for confinement and terminal illness. Again for these free partial withdrawals, the amount deducted from the accumulation value will equal the amount paid the client divided by the growth-to-date factor G, which equals (1+Balanced Allocation Factor). No MVA or Surrender Charge applies to free partial withdrawals.

The death benefit is equal to the greater of the Cash Surrender Value at time of death (including any MVA), and the Balance Allocation Value. (with no MVA). The Balanced Allocation Value equals the Accumulation Value times (1+Balanced Allocation Factor).

Annuitization occurs on the maturity date. The maturity date is fixed at a certain age, for example, 100. The annuity value is the Cash Surrender Value. According to normal company practice, the Withdrawal Charges and MVA is waived if the client purchases a SPIA within specified guidelines, for example: in years 2-5 the SPIA must be for 8 years or longer; in years 6+the SPIA must be for 5 years or longer.

The policy includes a modification from normal industry practice for confinement and terminal illness. The normal industry definitions are used. Two changes are made. First, the percentage payout has been increased such that the client can deplete 100% of the Accumulation Value without incurring any Withdrawal Charges or MVA. Any withdrawal under either waiver is processed just like a normal free partial withdrawal (i.e. it includes gains to date). That means the client will receive 100% of the Balanced Allocation Value if they deplete 100% of the Accumulation Value. Second, the waiver is available at all ages.

When a death benefit is paid, the beneficiary receives the greater of actual death benefit under the annuity, and the Enhanced Guaranteed Minimum Death Benefit calculated on the same date as the regular death benefit, where the Enhanced Guaranteed Minimum Death Benefit is equal to the premium accumulated at R % (where R is either 4 or 5 depending on the Withdrawal Charge term) until the rider premium completion date, adjusted for withdrawals.

At issue, the Enhanced Guaranteed Minimum Death Benefit is equal to the premium. Thereafter, it increases daily at the Enhanced Guarantee Minimum Death Benefit Rate of R %, until the Enhanced Guarantee Minimum Completion Date. After that point, it no longer increases.

The Enhanced Guarantee Minimum Death Benefit is reduced on a pro-rata basis for partial withdrawals. For example, if 10% of accumulation value is taken out, then the rollup death benefit is reduced by 10%. The Enhanced Guarantee Minimum Death Benefit Completion Date is the anniversary following a specified attained age, for example, 90. The annual rider premium is payable until the Rider Premium Completion Date. Although the Rollup Death Benefit stops increasing after the Death Benefit Completion Date, it is still paid out if higher than the regular annuity death benefit.

The rider premium is at a specified percentage, for example, 0.50% per year. In the discussion below, 0.5% is used as a non-limiting example. The premium is charged at the same time that interest is credited to the accumulation value. It is shown above as item C of the Index earnings factor. If a client does not elect lock-in during a term, then at the end of the term, the credited is reduced by the Accumulation value times 0.50% per year times the number of years in the term (or if less, the time between the start of the term and the Rider Premium Completion Date). However, the resulting credit cannot be less than zero.

If a client elects lock-in during a term, then at that time, the resulting credit is reduced by 0.50% times the number of full years plus a fraction for the partial year since the start of the term, or if less, the time between the start of the term and the Rider Premium Completion Date. As well, when calculating the guaranteed rate g, the end-of-term benefit is reduced by the premium times the number of years in the term. The rider cannot be dropped after it is elected. Rider premiums must be paid through the Rider Completion Date.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

1. A non-transitory machine readable medium having stored thereon data representing instructions for determining a set of equity-indexed crediting parameters C for an individual enhanced free partial withdrawal (EFPW) equity-indexed deposit product, wherein, when the instructions are executed by a computer system, the instructions cause the computer system to perform operations comprising:
determining said set of equity-indexed crediting parameters C at a time of product purchase by a seller, said equity-indexed crediting parameters C of said product comprising:
a set of profitability requirements R,
a principal amount P,
an account value A,
a cumulative enhanced free partial withdrawal limit L, and
a term T, with R, P, A, L, T, all determined by the seller;
determining a set of withdrawal times T′i<=T and withdrawal amounts Wi by the purchaser after the time of purchase;
determining a growth-to-date factor Gi>=1 by the seller at T′i using said equity-indexed crediting parameters C such that when the cumulative withdrawal Σ Wi is no greater than the cumulative enhanced free partial withdrawal limit L then each withdrawal Wi reduces the account value A by only Wi/Gi and if a sum of the withdrawal amounts Σ Wi exceeds the cumulative withdrawal limit L then each withdrawal exceeding the limit reduces the account value A by an excess;
iteratively generating a set of at least 100 yield curve and equity index scenarios based on valuation parameters;
setting a trial value Ci for said C;
generating a set of trial values for said T′i and said Wi for each said scenario;
calculating corresponding values for said A for each said scenario;
calculating a distribution D of profitability using said scenarios;
comparing said D with said R; and
in response to said comparing, computing a revised trial value Ci+1 for said C.

2. The non-transitory machine readable medium of claim 1, wherein the operations further comprise:
specifying at least one point-to-point equity index credit (PPEIC) by said set of equity-indexed crediting parameters C; and
calculating said at least one PPEIC using a percentage of an increase in an equity index, credited at the end of each policy year for said equity index, said at least one PPEIC no less than an annual minimum value.

3. The non-transitory machine readable medium of claim 1, wherein the operations further comprise:
specifying at least one point-to-point equity index credit (PPEIC) by said set of equity-indexed crediting parameters C; and
calculating said at least one PPEIC using a percentage of an increase in an equity index, credited at the end of each policy year for said equity index, said at least one PPEIC no less than an annual minimum value, and said at least one PPEIC no greater than an annual maximum value.

4. The non-transitory machine readable medium of claim 1, wherein the operations further comprise:
specifying at least one point-to-average equity index credit (PAEIC) by said set of equity-indexed crediting parameters C; and
calculating said at least one PAEIC using a percentage of an increase in an equity index from a year-start value to an average of values over a policy year for said equity index, credited at the end of each policy year for said equity index, said at least one PAEIC no less than an annual minimum value.

5. The non-transitory machine readable medium of claim 1, wherein the operations further comprise:
specifying at least one point-to-average equity index credit specified by said set of equity-indexed crediting parameters C; and
calculating said at least one point-to-average equity index credit (PAEIC) using a percentage of an increase in an equity index from a year-start value to an average of values over a policy year for said equity index, credited at the end of each policy year for said equity index, said at least one PAEIC no less than an annual minimum value, and said at least one PAEIC no greater than an annual maximum value.

6. The non-transitory machine readable medium of claim 1, wherein the operations further comprise:
specifying at least one point-to-point equity index credit (PPEIC) by said set of equity-indexed crediting parameters C; and
calculating said at least one PPEIC using a percentage of an increase in an equity index, credited at the end of an index interval equal to an integral number N of policy years, said at least one PPEIC ist no less than a minimum value calculated during each index interval.

7. The non-transitory machine readable medium of claim 1, wherein the operations further comprise:
specifying at least one point-to-point equity index credit (PPEIC) by said set of equity-indexed crediting parameters C; and
calculating said at least one PPEIC using a percentage of an increase in an equity index, credited at the end of an index interval equal to an integral number N of policy years, said at least one PPEIC no less than a minimum value and said at least one PPEIC no greater than a maximum value calculated during each index interval.

8. The non-transitory machine readable medium of claim 1, wherein the operations further comprise:
specifying at least one point-to-average equity index credit (PAEIC) by said set of equity-indexed crediting parameters C; and
calculating said at least one PAEIC using a percentage of an increase in an equity index from a year-start value to an average of values over an index interval equal to an integral number N of policy years, credited at the end of said index interval, said at least one PAEIC no less than a minimum value calculated during each index interval.

9. The non-transitory machine readable medium of claim 1, wherein the operations further comprise:
specifying at least one point-to-average equity index credit (PAEIC) by said set of equity-indexed crediting parameters C; and
calculating said at least one PAEIC using a percentage of increase in an equity index from a starting value to an average of values over an index interval equal to an integral number N of policy years, credited at the end of said index interval, said at least one PAEIC no less than a minimum value, and said at least one PAEIC no greater than a maximum value calculated during each index interval.

10. The non-transitory machine readable medium of claim 1, wherein the operations further comprise:
specifying at least one point-to-point equity index credit (PPEIC) by said set of equity-indexed crediting parameters C;
calculating said at least one PPEIC using a weighted sum, said weighted sum adding a compounded value calculated using a declared rate to a percentage of change in an equity index; and
crediting said at least one PPEIC at the end of an index interval equal to an integral number N of policy years, said at least one PPEIC no less than a minimum value during each index interval.

11. The non-transitory machine readable medium of claim 1, wherein the operations further comprise:
specifying at least one point-to-point equity index credit (PPEIC) by said set of equity-indexed crediting parameters C;
calculating said at least one PPEIC using a weighted sum, said weighted sum adding a compounded value calculated using a declared rate to a percentage of change in an equity index; and
crediting said at least one PPEIC at the end of an index interval equal to an integral number N of policy years, said at least one PPEIC no less than a minimum value, and said at least one PPEIC no greater than a maximum value during each index interval.

12. The non-transitory machine readable medium of claim 1, wherein the operations further comprise:
specifying at least one point-to-average equity index credit (PAEIC) by said set of equity-indexed crediting parameters C;
calculating said at least one PAEIC using a weighted sum, said weighted sum adding a compounded value calculated using a declared rate to a percentage of change in an equity index from a starting value to an average of values over an index interval equal to an integral number N of policy years; and
crediting said at least one PAEIC at the end of said index interval, said at least one PAEIC no less than a minimum value during each index interval.

13. The non-transitory machine readable medium of claim 1, wherein the operations further comprise:
specifying at least one point-to-average equity index credit (PAEIC) by said set of equity-indexed crediting parameters C;
calculating said at least one PAEIC using a weighted sum, said weighted sum adding a compounded value calculated using a declared rate to a percentage of change in an equity index from a starting value to an average of values over an index interval equal to an integral number N of policy years; and
crediting said at least one PAEIC at the end of said index interval, said at least one PAEIC no less than a minimum value, and said at least one PAEIC no greater than a maximum value during each index interval.
